(19) United States
(12) Patent Application Publication
(10) Pub. No.: US 2026/0010293 A1
(43) Pub. Date: Jan. 8, 2026

(54) OPTIMIZED OUT-OF-ORDER DATA FETCHING IN A MEMORY SUB-SYSTEM

(71) Applicant: MICRON TECHNOLOGY, INC., Boise, ID (US)

(72) Inventors: Jameer Mulani, Bangalore (IN); Jonathan S. Parry, Boise, ID (US)

(21) Appl. No.: 19/252,306

(22) Filed: Jun. 27, 2025

Related U.S. Application Data
(60) Provisional application No. 63/667,358, filed on Jul. 3, 2024.

(51) Int. Cl. G06F 3/06

(52) U.S. Cl. CPC G06F 3/0613; G06F 3/0659; G06F 3/0673

(57) ABSTRACT

A system includes a memory device including a first set of dies and a second set of dies; and a processing device, operatively coupled with the memory device, to perform operations including sending, to a host system, a request to fetch data out of order; fetching, from the host system, a plurality of first data elements, wherein each first data element of the plurality of first data elements corresponds to a first die of the first set of dies of the memory device; storing the plurality of first data elements in a write buffer of the system; and writing the plurality of first data elements from the write buffer to the first die in parallel with performing a first folding operation by copying data from the first set of dies to the second set of dies of the memory device.

### RELATED APPLICATIONS

This application claims the benefit of U.S. Provisional Patent Application No. 63/667,358, filed July 3, 2024, the entire contents of which are incorporated by reference herein.

### TECHNICAL FIELD

Embodiments of the disclosure relate generally to memory sub-systems, and more specifically, relate to optimized out-of-order data fetching in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example block diagram of a system that implements optimized out-of-order data fetching in a memory sub-system in accordance with some embodiments of the present disclosure.

FIG. 3 illustrates an example of in-order data fetching and an example of out-of-order data fetching in accordance with some embodiments of the present disclosure.

FIGS. 4A and 4B illustrate example operations of host write in parallel with folding operations in accordance with some embodiments of the present disclosure.

FIGS. 5 and 6 are flow diagrams of example methods for optimized out-of-order data fetching in a memory sub-system in accordance with some embodiments of the present disclosure.

FIG. 7 is a block diagram of an example computer system in which embodiments of the present disclosure may operate.

### DETAILED DESCRIPTION

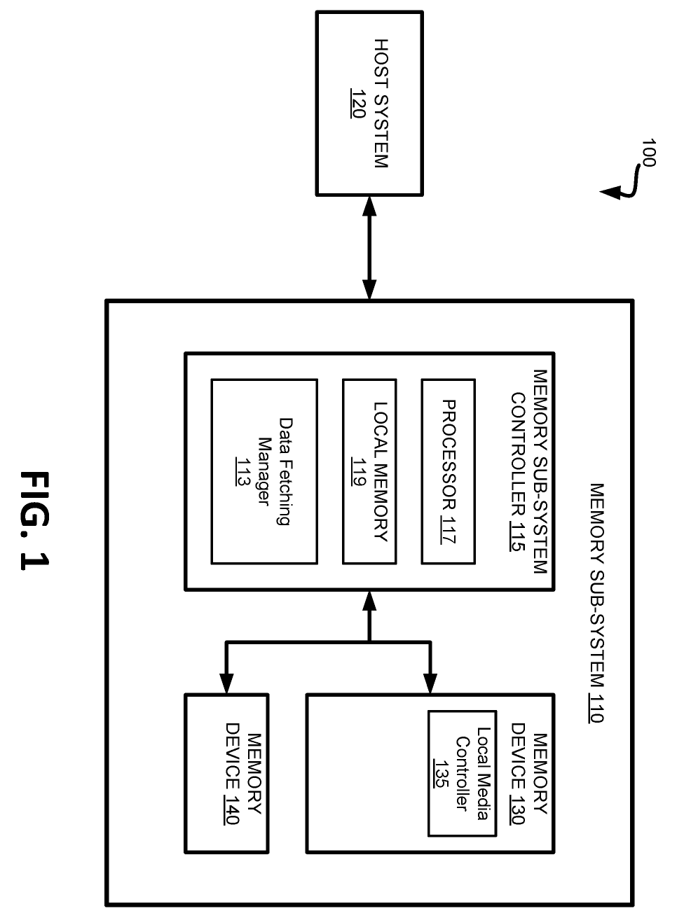

Aspects of the present disclosure are directed to optimized out-of-order data fetching in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non- volatile memory devices is a negative-and (NAND) memory device. Other examples of non- volatile memory devices are described below in conjunction with FIG. 1. A non-volatile memory device is a package of one or more dies. Each die can include one or more memory planes ("planes"). For some types of non-volatile memory devices (e.g., NAND devices), each plane includes a set of physical blocks ("blocks"). Each block includes a set of pages. Each page includes a set of memory cells ("cells"). A cell is an electronic circuit that stores information. Depending on the cell type, a cell can store one or more bits of binary information, and has various logic states that correlate to the number of bits being stored. The logic states can be represented by binary values, such as "0" and "1", or combinations of such values. A block refers to a unit of the memory device used to store data and can include a group of memory cells, a word line group, a word line, or individual memory cells.

Data operations (also referred to as "memory access operations") can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data in the memory device at the memory sub-system and to read data from the memory device of the memory sub-system.

The data to be read or written, as specified by a host request, is referred to as "host data." A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), and the like. For simplicity, where "data" is referred to hereafter, such data can be understood to refer to at least host data, but can also refer to other data such as media management data and/or system data.

A memory device can include multiple memory cells arranged in a two-dimensional grid. The memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

One type of cell is a single level cell (SLC), which stores 1 bit per cell and defines 2 logical states ("states") ("1" or "LO" and "0" or "L1") each corresponding to a respective VT level. For example, the "1" state can be an erased state and the "0" state can be a programmed state (L1). Another type of cell is a multi-level cell (MLC), which stores 2 bits per cell and defines 4 states ("11" or "LO", "10" or "L1", "01" or "L2" and "00" or "L3") each corresponding to a respective VT level. For example, the "11" state can be an erased state and the "01", "10" and "00" states caneach be a respective programmed state. Another type of cell is a triple level cell (TLC), which stores 3 bits per cell and defines 8 states ("111" or "LO", "110" or "L1", "101" or "L2", "100" or "L3", "011" or "L4", "010" or "L5", "001" or "L6", and "000" or "L7") each corresponding to a respective VT level. For example, the "111" state can be an erased state and each of the other states can be a respective programmed state. Another type of a cell is a quad-level cell (QLC), which stores 4 bits per cell and defines 16 states LO-L15, where LO corresponds to "1111" and L15 corresponds to "0000". Another type of cell is a penta-level cell (PLC), which stores 5 bits per cell and defines 32 states. Other types of cells are also contemplated. Thus, an n-level cell can use 2" levels of charge to store n bits. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

Each type of memory cell (e.g., SLCs, MLCs, TLCs and QLCs) can exhibit different characteristics and advantages. For example, an SLC can have a lower read latency (e.g., how long it takes for data stored at the SLC to be read), a faster programming time (e.g., how long it takes to program data received from the host system to the cell for storage) and a greater reliability for data stored at the SLC than the other types of memory cells. Although SLCs offer superior performance characteristics, manufacturing memory devices that include only SLC memory cells can be less cost-effective in comparison with memory devices having higher density cells (e.g., MLCs, TLCs and QLCs), which store more bits per cell. Accordingly, some memory cells can be configured as SLCs, while the rest of the memory cells can be higher density cells. Data is first written to the SLC portion of the memory device and later transferred to a higher density portion of the memory device when the memory sub-system is not busy servicing host requests. The use of SLC cells in this way can be termed a "SLC cache." The SLC cache provides a balance between the speed of SLC memory cells with the storage capacity of higher density memory cells. In some memory implementations, as the device fills up, memory cells configured as SLC cache are migrated to higher density memory cells to increase data storage capacity.

Some memory devices can perform a media management operation (e.g., a folding operation). The folding operation involves copying data from a source management unit (e.g., a block, superblock, a page, etc.) to a destination management unit (e.g., a block, superblock, a page, etc.) available on the memory device. For example, the folding operation includes retrieving data from the source management units (e.g., as a cache) and programming the data on certain types of memory cells in the destination management units. For example, the destination management units can include memory cells of quadruple-level cell (QLC) type, storing a 4-bit value per cell. A two-pass programming operation can be introduced to program data to the QLC in order to mitigate the program disturb, which is caused by cell-to-cell interference where a bit is unintentionally programmed from a "1" to a "0" during a page-programming event.

Some memory sub-systems, such as those including multiple memory devices (i.e., memory dies) can perform memory access operations to write host data to the memory devices concurrently with performing the folding operations in the memory devices. This allows host data to be written to at least one die at the same time that a folding operation is occurring, thereby increasing the quality of service (QoS) and performance of the memory sub-system. To maintain a good overall QoS, the ratio of dies used for host write and folding operation needs to be controlled. The amount of host data that can be written in one programming cycle of the folding operation is limited by the size of the write buffer, where the write buffer is a cache for storing the host data to be stored eventually in the memory device. For example, in a case that the ratio of a number of dies used for host writes and a number of dies used for folding operations is 1:3, one programming cycle of the folding operation on QLC memory arrays may be 4ms, and assuming that the size of the write buffer is around 576KB for a host write on the TLC memory arrays, the amount of host data that can be written during one programming cycle of the folding operation is around 192KB, which results in the host write speed ("performance") as 48 MB/s. Such performance needs to be improved so that more host data can be written during one programming cycle of the folding operation.

Aspects of the present disclosure address the above and other deficiencies by implementing a memory sub-system that provides optimized out-of-order data fetching for host writes in parallel with the folding operation. In contrast to using in-order data fetching, which does not address the limit on host write performance as described above, a memory sub-system controller can fetch the host data out of order such that more host data can be written during one programming cycle of the folding operation. Specifically, the memory sub-system controller may send a request to a host system to enable out-of-order data fetching. For example, the memory sub- system controller may set a field in the universal flash storage (UFS) protocol information units (UPIU) included in the request. Upon receiving the request, the host system may enable a configuration setting for out-of-order data fetching. The request may include logical addresses (e.g., LBA) or other identifiers to identify data that is subject to the out-of-order data fetching. In some implementations, the memory sub-system controller may send a separate request for data that is subject to the out-of-order data fetching, for example, for each programming cycle of the folding operation.

Once the configuration setting for out-of-order data fetching is enabled, the memory sub-system controller may fetch, from the host system, multiple units of data to be stored in a first die (e.g., data for die 0). The data unit refers to a management unit of data in a predefined size. For example, the predefined size may be a size (e.g., 192KB) of host data that is traditionally written in one programming cycle of the folding operation. The multiple data units (e.g., three data units) are fetched out of order from the host system. That is, the memory sub-system controller may fetch one data unit (e.g., data unit for die 0) and skip fetching one or more next data units (e.g., a data unit for die 2 and a data unit for die 3 can be skipped, while a data unit for die 1 may be fetched at the end for use in the next iteration on the second die) continually until the pre-defined number (e.g., three) of data units (e.g., data units for die 0) is fetched.

The memory sub-system controller may store the multiple fetched data units in a write buffer of the memory sub-system. The memory sub-system controller may write the multiple data units from the write buffer to the first die (e.g., die 0) of SLC/MLC/TLC memory arrays of the memory device in parallel with performing a first folding operation, where performing the first folding operation involves copying data from SLC/MLC/TLC memory arrays (e.g., other dies rather than die 0) to QLC memory arrays (e.g., die 1, die 2, die 3) of the memory device. TheSLC/MLC/TLC memory arrays represent any one of SLC memory arrays, MLC memory arrays, or TLC memory arrays.

Responsive to completing the first folding operation, the memory sub-system controller may rotate the first die (e.g., die 0) from the first set of dies in SLC/MLC/TLC memory arrays to the second set of dies in QLC memory arrays, and rotate another die (e.g., die 1) of the second set of dies from the second set of dies to the first set of dies. The memory sub-system controller may continue fetching, from the host system, multiple data units of data to be stored in a second die (e.g., data for die 1), storing the fetched multiple data units in the write buffer, writing the multiple data units from the write buffer to the second die (e.g., die 1) of SLC/MLC/TLC memory arrays of the memory device in parallel with performing a second folding operation, where performing the second folding operation involves copying data from SLC/MLC/TLC memory arrays (e.g., other dies rather than die 1) to QLC memory arrays (e.g., die 2, die 3, die 0) of the memory device. Responsive to completing performing the second folding operation, the memory sub-system controller may repeatedly perform the operations including rotating, fetching, storing, and writing during folding as described above.

To compare with example illustrated above, in a case that the ratio of a number of dies used for host writes and a number of dies used for folding operations is 1:3, one programming cycle of the folding operation on QLC memory arrays may be 4ms, and assuming that the size of the write buffer is around 576KB for a host write on the TLC memory arrays, the amount of host data that can be written during one programming cycle of the folding operation is around 576KB, which results in the host write speed ("performance") as 144 MB/s. As such, more host data is written during one programming cycle of the folding operation.

Advantages of the present disclosure include, but are not limited to achieving better parallelism across the dies of a memory device for host write and folding. The memory sub- system controller can avoid only writing one data unit of the host data while performing the folding operation in the memory device. Instead, the memory sub-system controller can fetch data out of order from a host system and write multiple data units of the host data while performing the folding operation in the memory device. Accordingly, the overall QoS and performance of thememory sub-system can be improved. Also, the out-of-order data fetching from a host system would not affect the order of data stored in the memory device nor the folding operation. Further, for the same performance of the memory sub-system, a smaller size of the write buffer is required compared with the traditional case.

FIG. 1 illustrates an example computing system 100 that includes a memory sub- system 110 in accordance with some embodiments of the present disclosure. The memory sub- system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi- Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in- line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, "coupled to" or "coupled with" generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub- system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point ("3D cross-point") memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non- volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)- MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub- system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. lA has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 includes local media controllers 135 that operate in conjunction with memory sub-system controller 115 to execute operations on one or more memory cells of the memory device(s) 130. An external controller (e.g., memory sub- system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a data fetching manager 113 that can implement out-of-order data fetching for host writes while performing a folding operation in the memory device(s), such as memory device 130. In some embodiments, memory sub-system controller 115 includes at least a portion of data fetching manager 113. In some embodiments, data fetching manager 113 is part of host system 110, an application, or an operating system. In other embodiments, local media controller 135 includes at least a portion of data fetching manager 113 and is configured to perform the functionality described herein. Further details with regards to the operations of data fetching manager 113 are described below.

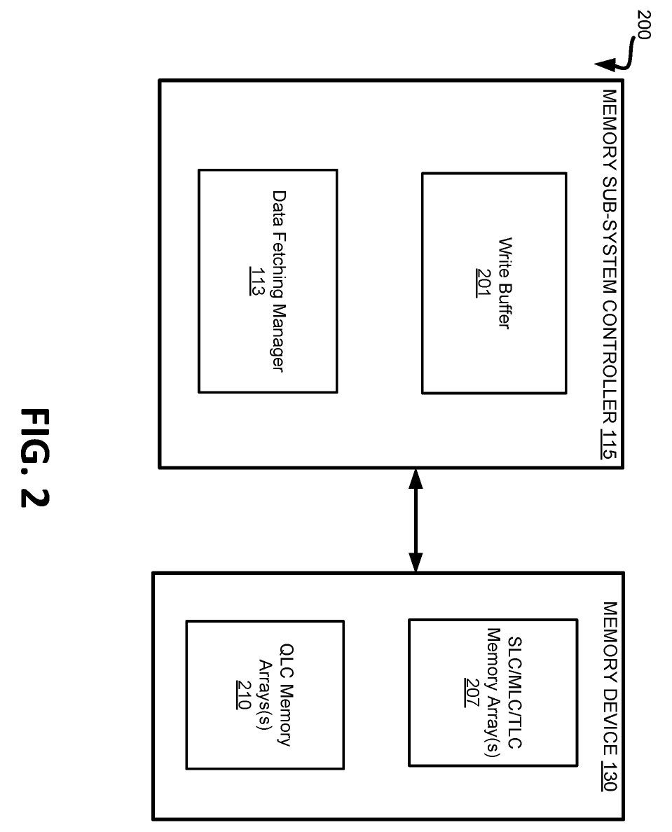

FIG. 2 illustrates an example of writing host data to a memory device and at the same time performing folding operations, within the memory device, from source SLC/MLC/TLC memory arrays (e.g., management units, such as block stripes) to destination QLC memory arrays (e.g., management units, such as block stripes). SLC/MLC/TLC memory arrays represent any one of SLC memory arrays, MLC memory arrays, or TLC memory arrays. FIG. 2 illustrates a block diagram of a system that fetches out-of-order data from a host system 120 for a host write and performs folding operations in accordance with some embodiments of the present disclosure. System 200 can represent memory sub-system 110 of FIG. 1. Referring to FIG. 2, system 200 can include SLC/MLC/TLC memory arrays 207 (as part of memory device 130), quad-level cell (QLC) memory arrays 210 (as part of memory device 130), and memory sub-system controller 115. Memory sub-system controller 115 can include write buffer 201 and data fetching manager 113.

Write buffer 201 (e.g.., static random access memory (SRAM)) can store write commands submitted to the memory sub-system by the host system 120 and/or write commands initiated by memory sub-system controller 115 (e.g., garbage collection). Memory sub-system controller 115 can execute the write commands to block stripes in the SLC/MLC/TLC memory arrays 207.

The data fetching manager 113 can manage the data fetched from the host system 120 and to be written to the memory device 130. For example, the data fetching manager 113 may send, to a host system 120, a request to fetch out-of-order data. The data fetching manager 113 may set a field in the request, where the request comprises universal flash storage (UFS) protocol information units (UPIU). The request may include logical addresses (e.g., LBA) or other identifiers to identify data that is subject to the out-of-order data fetching. In some implementations, the data fetching manager 113 may send a separate request for data that is subject to the out-of-order data fetching, for example, for each programming cycle of the folding operation.

The host system 120 may receive, from the data fetching manager 113, the request to fetch data out of order, and upon receiving the request, enable a configuration setting for out-of- order data fetching. The host system 120 may send to the data fetching manager 113, out-of-order data according to the request. The data fetching manager 113 may store the out-of-order data in the write buffer 201.

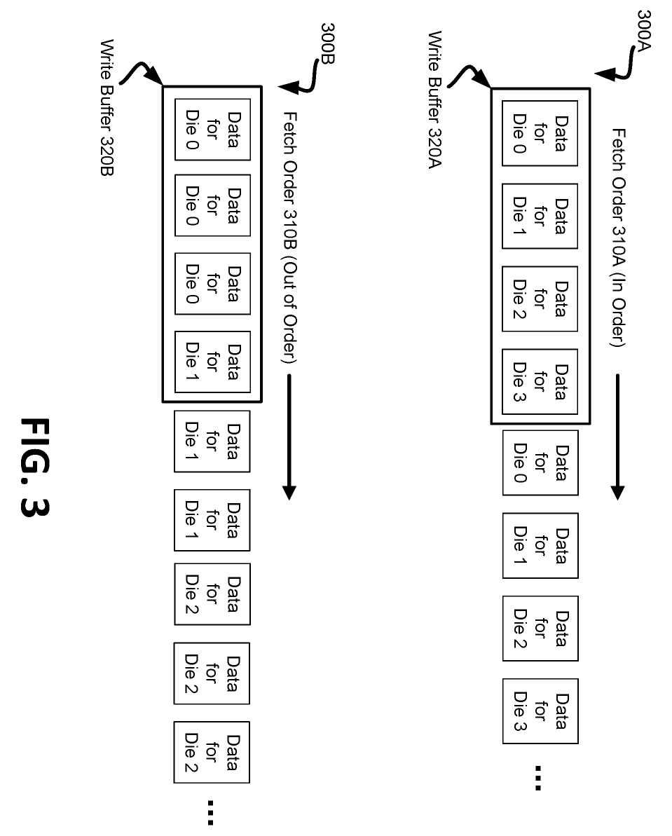

FIG. 3 illustrates an example of in-order data 300A fetched from the host system 120, where the fetch order 310A is data to be stored in die 0 (i.e., data for die 0), data to be stored in die 1 (i.e., data for die 1), data to be stored in die 2 (i.e., data for die 2), data to be stored in die 3 (i.e., data for die 3), and continues repeatedly (i.e., one time for data of each die). That is, the host system 120 may send the data in sequence as in-order data 300A to the controller 115. In one example, the host system 120 provides the data in sequence as data for die 0, data for die 1, data for die 2, data for die 3, and the size of write buffer 320A can store data for die 0, data for die 1, data for die 2, data for die 3.

FIG. 3 illustrates an example of out-of-order data 300B fetched from the host system 120 according to the present disclosure, where the fetch order 310B is data to be stored in die 0 (i.e., data for die 0), data to be stored in die 0 (i.e., data for die 0), data to be stored in die 0 (i.e., data for die 0), data to be stored in die 1 (i.e., data for die 1), data to be stored in die 1 (i.e., data for die 1), data to be stored in die 1 (i.e., data for die 1), data to be stored in die 2 (i.e., data for die 2), data to be stored in die 2 (i.e., data for die 2), data to be stored in die 2 (i.e., data for die 2), data to be stored in die 3 (i.e., data for die 3), data to be stored in die 3 (i.e., data for die 3), data to be stored in die 3 (i.e., data for die 3), and continues repeatedly (i.e., three times for data of each die). That is, the host system 120 may send the data, which is not in sequence, as out-of-order data 300B to the data fetching manager 113. In one example, the host system 120 provides the data, which is not in the sequential order, as data for die 0, data for die 0, data for die 0, data for die 1, and the size of write buffer 320B (e.g., can be the same as write buffer 201) can store data for die 0, data for die 0, data for die 0, data for die 1. In some implementations, each "data for die" box shown in FIG. 3 can represent a data unit.

Referring back to FIG. 2, the data fetching manager 113 can write the out-of-order data (e.g., data 300B) from the write buffer 201 to the SLC/MLC/TLC memory arrays 207 (e.g., a first set of dies) of the memory device 130 in parallel with performing folding operation(s) by copying data from SLC/MLC/TLC memory arrays 207 (e.g., a first set of dies) to the QLC memory arrays 210 (e.g., a second set of dies) of the memory device 130. To perform the folding operation(s), the data fetching manager 113 can perform a two-pass programming operation on the set of QLC memory arrays 210 to program the data on the QLC memory arrays 210. During the first pass of the two-pass programming operation, a first set of voltages is applied. During the second pass of the two-pass programming operation, a second set of voltages is applied.

Specifically, each programming pass in the two-pass programming operation would apply appropriate programming voltages to a given wordline in order place appropriate charges on the charge storage nodes of the memory cells that are connected to the wordline. In some embodiments, the memory controller can implement a two-pass programming algorithm, which involves programming the lower page (LP) bits, the upper page (UP) bits, and the extra page (XP) bits of the memory cells by the first programming pass, followed by programming the top page(TP) bits of the memory cells by the second programming pass. This algorithm can be referred to as 8-16 programming algorithm, to reflect the number of memory cell states programmed by each pass. Thus, each memory cell stores sixteen states that are programmable by two sequential programming passes. In some embodiments, the two-pass programming operation can implement a coarse-fine programming algorithm. The first programming pass forms, for each memory cell, sixteen logical states after coarse programming. A set of threshold voltage distributions after coarse programming are highly overlapped. This overlapping occurs due to less precise programming in which each threshold voltage distribution widely covers a range of threshold voltage that coarsely approximates a more accurate (finer) threshold voltage range that is intended for each respective Vt distribution. The second programming pass forms, for each memory cell, sixteen logical states after fine programming. When fine programming is completed, e.g., to a final set of threshold voltage distributions, each threshold voltage distribution is more finely defined over a focused threshold voltage range intended for each respective logical state. When this occurs, the read window margins between respective threshold voltage distributions are widened such that individual logical states across different memory cells of a set of memory cells can be distinguished when read.

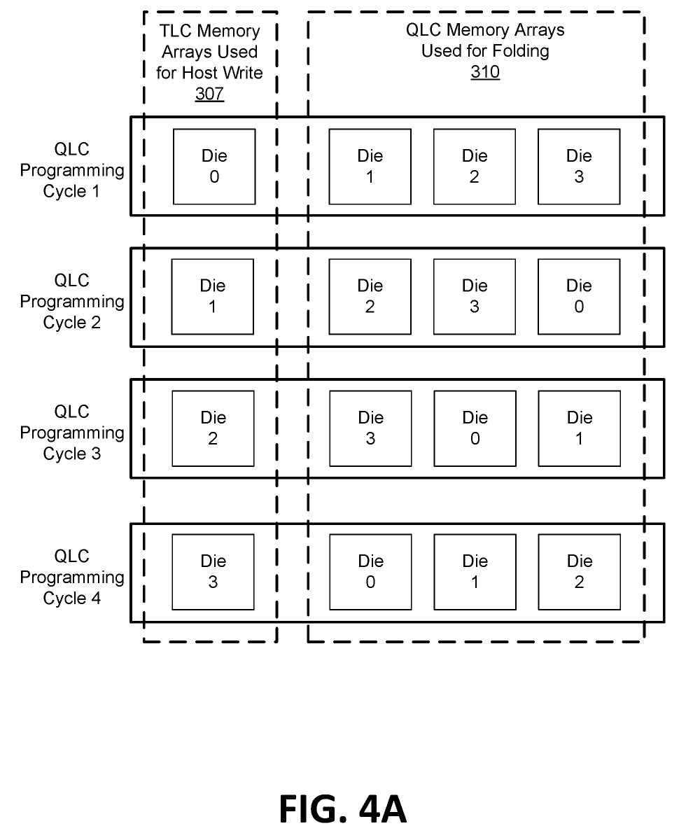

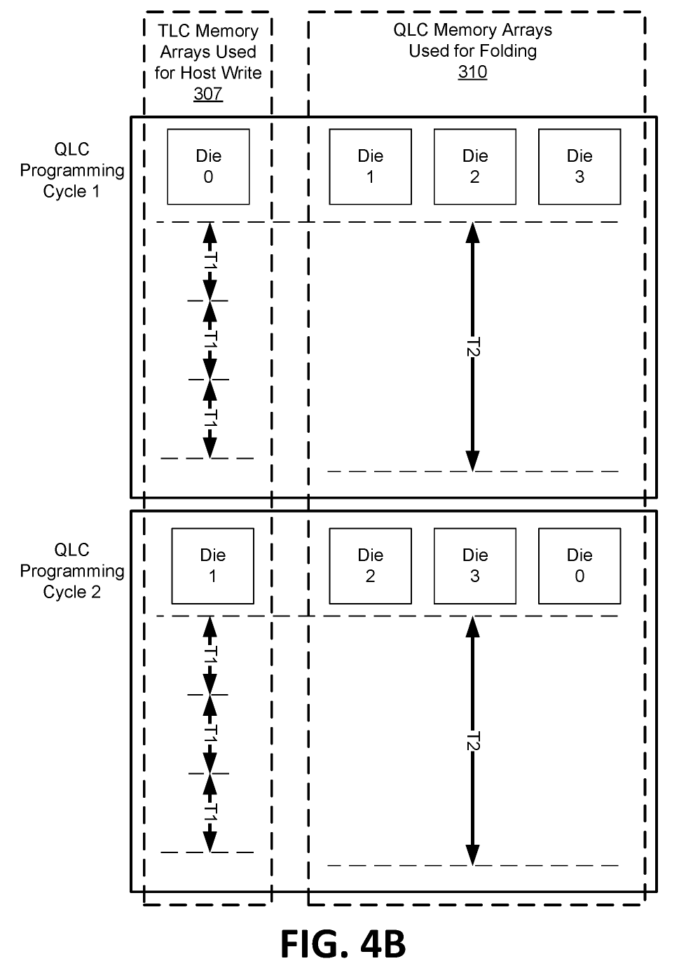

For each programming pass of the two-pass programming operation, the time used for applying the voltages can be referred to as a QLC programming cycle. One QLC programming cycle may represent a time duration of performing a folding operation, where at the end of the QLC programming cycle, the respective folding operation is completed. FIG. 4A illustrates examples of operations performed by the data fetching manager 113, including writing the out-of- order data (e.g., data 300B) from the write buffer 201 to the TLC memory arrays 307 in parallel with performing folding operation(s) on the QLC memory arrays 310 over several QLC programming cycles. The dies used in performing these operations are rotated as illustrated in FIG. 4A. Specifically, referring to FIG. 4A, for QLC programming cycle 1, the data fetching manager 113 may store the data fetched from the host system to die 0 of the TLC memory arrays 307 and at the same time perform the folding operation(s) on die 1, die 2, and die 3 of the QLC memory arrays 310. Next, for QLC programming cycle 2, the data fetching manager 113 may store the data fetched from the host system to die 1 of the TLC memory arrays 307 and at the same time perform the folding operation(s) on die 2, die 3, and die 0 of the QLC memory arrays 310. Next, for QLC programming cycle 3, the data fetching manager 113 may store the data fetched from the host system to die 2 of the TLC memory arrays 307 and at the same time perform the folding operation(s) on die 3, die 0, and die 1 of the QLC memory arrays 310. Next, for QLC programming cycle 4, the data fetching manager 113 may store the data fetched from the host system to die 3 of the TLC memory arrays 307 and at the same time perform the folding operation(s) on die 0, die 1, and die 2 of the QLC memory arrays 310. For the next programming cycle, the , the data fetching manager 113 may use the dies the same as shown in programming cycle 1, i.e., storing the data fetched from the host system to die 0 of the TLC memory arrays 307 and at the same time performing the folding operation(s) on die 1, die 2, and die 3 of the QLC memory arrays 310, and the data fetching manager 113 may continue the operations as described in programming cycles 2, 3, 4, and repeat the programming cycles.

For each programming cycle, the data fetching manager 113 is capable of writing more data from the host system to the TLC memory arrays according to the present disclosure as shown in FIG. 4B. To simplify the description, FIG. 4B illustrates QLC programming cycle 1 and QLC programming cycle 2 of FIG. 4A as examples. Traditionally, in QLC programming cycle 1, the controller 115 may perform the folding operation(s) on die 1, die 2, and die 3 of the QLC memory arrays 310 and the folding operation may take the time T2 (e.g., 4ms) to complete; the controller 115 may store the data fetched from the host system (referred to as host write) to die 0 of the TLC memory arrays 307 and the host write may take the time T1 (e.g., 1.2ms). Because the data is fetched in order, for example, as shown in FIG. 3, the controller 115 needs to wait until the end of the QLC programming cycle 1 and then fetch the data for die 1 and store this data on die 1 in the QLC programming cycle 2. Similarly, in QLC programming cycle 2, the controller 115 may perform the folding operation(s) on die 2, die 3, and die 0 of the QLC memory arrays 310 and the folding operation may take the time T2 (e.g., 4ms) to complete; the controller 115 may store the data fetched from the host system (referred to as host write) to die 1 of the TLC memory arrays 307 and the host write may take the time T1 (e.g., 1.2ms).

Compared with the traditional way described above, referring to FIG, 4B , in QLC programming cycle 1, the data fetching manager 113 may perform the folding operation(s) on die 1, die 2, and die 3 of the QLC memory arrays 310 and the folding operation may take the time T2 (e.g., 4 ms) to complete; the data fetching manager 113 may store the data fetched from the host system (referred to as host write) to die 0 of the TLC memory arrays 307 for three times, and each of the host write may take the time T1 (e.g., 1.2ms). Because the data is fetched out of order, for example, as shown in FIG. 3B , the data fetching manager 113 does not need to wait until the end of the QLC programming cycle 1 to store another data for die 0. As such, in QLC programming cycle 1, the data fetching manager 113 may store the data for die 0 for three times, and the total time used for the host write (e.g., 1.2ms multiplying 3) is still within the duration of time T2.

Responsive to completing performing the folding operation for the QLC programing cycle 1, the data fetching manager 113 may rotate die 0 from the first set of dies to the second set of dies, and rotate die 1 of the second set of dies from the second set of dies to the first set of dies, as discussed in FIG. 4A. Similarly as described above, in QLC programming cycle 2, the data fetching manager 113 may perform the folding operation(s) on die 2, die 3, and die 0 of the QLC memory arrays 310 and the folding operation may take the time T2 (e.g., 4ms) to complete; the data fetching manager 113 may store the data fetched from the host system (referred to as host write) to die 1 of the TLC memory arrays 307 for three times, and each of the host write may take the time T1 (e.g., 1.2ms). As such, a time difference between time used in writing multiple times (e.g., three times of T1) of data for die 0 and time used in performing the first folding operation (e.g., T2) on die 1, die 2, die 3 is less than time used in writing one time (e.g., T1) of data for die 0; a time difference between time used in writing multiple times (e.g., three times of T1) of data for die 1 and time used in performing the first folding operation (e.g., T2) on die 2, die 3, die 0 is less than time used in writing one time (e.g., T1) of data for die 1. Similarly, as such, in QLC programming cycle 2, the data fetching manager 113 may store the data for die 1 for three times, and the total time used for the host write (e.g., 1.2ms multiplying 3) is still within the duration of time T2. It is noted that although FIGS. 4A-4B illustrate TLC memory arrays as examples for host write, other types of memory arrays including MLC and/or SLC memory arrays are also applicable.

Referring back to FIG. 2, the data fetching manager 113 can communicate to a host system 120, a notification the write operation of the host data has been completed. When the write operation completes, a completion notification is sent back to the host process that initiated the write operations. In some implementations, the data fetching manager 113 can communicate to a host system 120 upon completing each QLC programming cycle. In some implementations, the data fetching manager 113 can communicate to a host system 120 upon completing multiple QLC programming cycles.

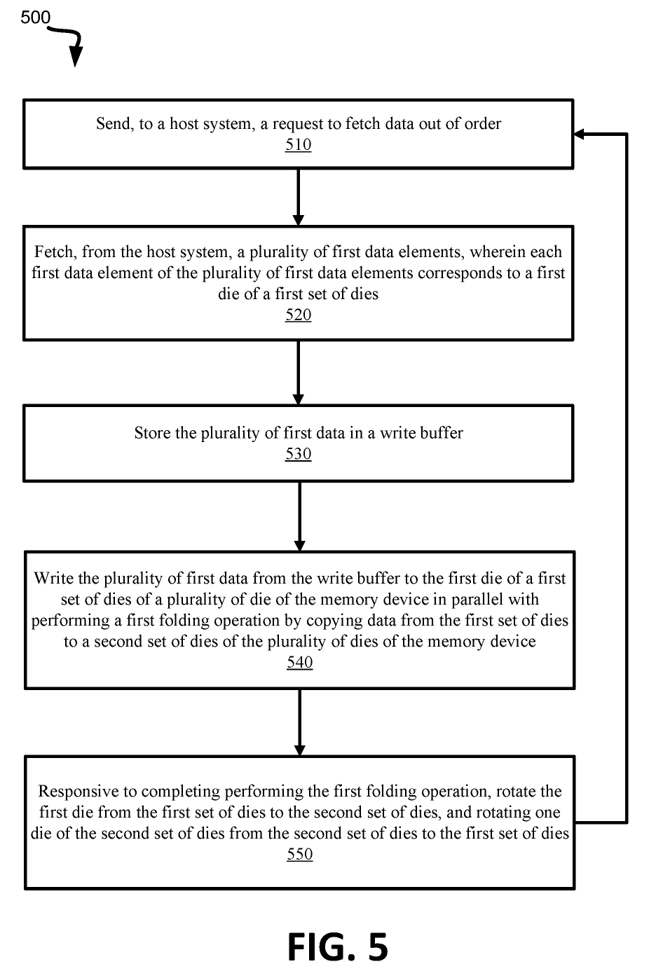

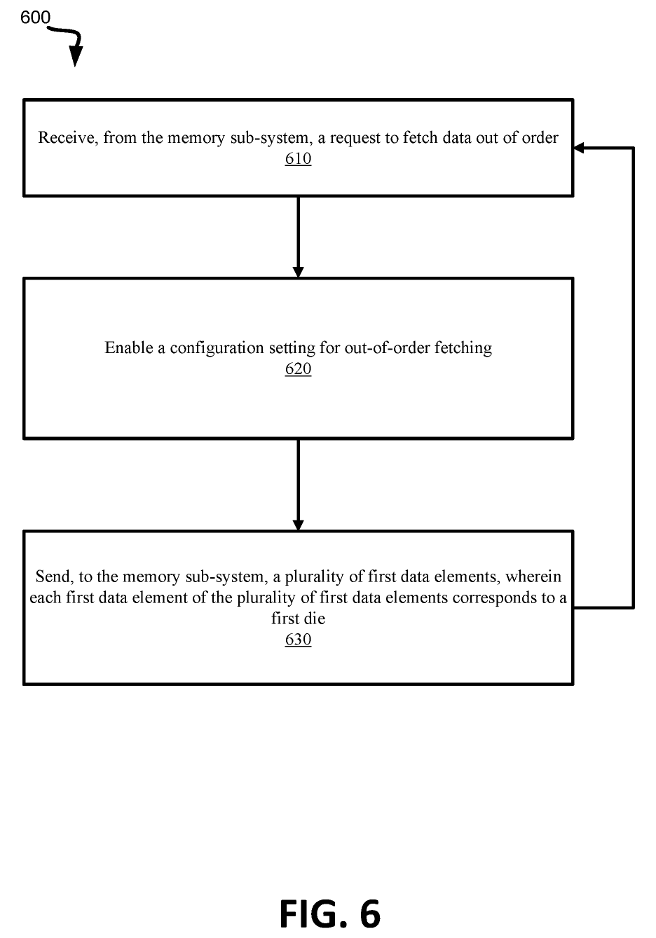

FIGS. 5 and 6 are flow diagrams of example methods 500 and 600 for optimized out- of-order data fetching in a memory sub-system, in accordance with some embodiments of the present disclosure. The methods 500 and 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the data fetching manager 113 of FIGS. 1 and 2. In some embodiments, the method 600 is performed by the host system 120 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 5, at operation 510, the processing logic may send, to a host system (e.g., the host system 120 of FIG. 1), a request to fetch data out of order. In some embodiments, the processing logic may set a field in the request, where the request comprises universal flash storage (UFS) protocol information units (UPIU).

In some embodiments, the processing logic may generate the request to fetch data out of order upon receiving a request to perform a memory access operation. For example, the processing logic may first receive a request to perform a memory access operation (e.g., a write command) from a host system (e.g., the host system 120 of FIG. 1 ). In some embodiments, the write command may include a logical address of the data (e.g., the LBA associated with the memory access operation). The LBA can reference dies (e.g., the blocks of the dies) on which the memory access operation is to be performed.

At operation 520, the processing logic may fetch, from the host system (e.g., the host system 120 of FIG. 1), a plurality of first data elements, wherein each first data elements of the plurality of first data elements corresponds to a first die. In some implementations, the first data elements may be represented by a data unit, where the plurality of first data elements can be represented by multiple data units, and the number of data units that can be fetched can be pre- determined or dynamic number based, e.g., on the design and/or physical characteristics of the memory device. In some implementations, the plurality of first data elements is not stored in a sequential order in the host system, and each first data element of the plurality of first data elements is associated with a respective logical address range of a plurality of logical address ranges.

At operation 530, the processing logic may store the plurality of first data elements in a write buffer (e.g., the write buffer 201 of FIG. 2) of the memory sub-system (e.g., the memory sub-system 110 of FIG. 1). In some implementations, the plurality of first data elements may be three data units for die 0 shown in FIG. 3B.

At operation 540, the processing logic may write the plurality of first data from the write buffer (e.g., the write buffer 201 of FIG. 2) to the first die of a first set of dies (e.g., the SLC/MLC/TLC memory arrays 207 of FIG. 2) of the memory device in parallel with performing a first folding operation, where performing the first folding operation involves copying data from the first set of dies (e.g., the SLC/MLC/TLC memory arrays 207 of FIG. 2) to a second set of dies (e.g., the QLC memory arrays 210 of FIG. 2) of the memory device (e.g., the memory device 130 of FIGS. 1 and 2). In some implementations, the copied data is data stored on other dies of the first set of dies rather than the first die. In some implementations, the time difference between time used in writing the plurality of first data and time used in performing the first folding operation is less than time used in writing one first data of the plurality of first data. In some implementations, the first set of dies runs in at least one of: a single level cell (SLC) mode, a multi-level cell (MLC) mode, or a triple level cell (TLC) mode, and the second set of dies runs in a quad-level cell (QLC) mode.

At operation 550, responsive to completing the first folding operation, the processing logic may rotate the first die from the first set of dies (e.g., the SLC/MLC/TLC memory arrays 207 of FIG. 2) into the second set of dies (e.g., the QLC memory arrays 210 of FIG. 2), and rotate one die of the second set of dies (e.g., the QLC memory arrays 210 of FIG. 2) from the second set of dies into the first set of dies (e.g., the SLC/MLC/TLC memory arrays 207 of FIG. 2). After rotating, the operations performed at operations 510 to 550 are performed repeatedly on a second die with second data, a third die with third data, etc. For example, for the second die with second data, the processing logic may send a request for out-of-order data fetching, fetch, from the host system, a plurality of second data elements, wherein each second data element of the plurality of second data elements corresponds to a second die of the first set of dies, store the plurality of second data in the write buffer, and write the plurality of second data element from the write buffer to the second die of the first set of dies of the memory device in parallel with performing a second folding operation, where performing the second folding operation involves copying data from the first set of dies to the second set of dies of the memory device, where the copied data is data stored on other dies of the first set of dies rather than the second die.

Referring to FIG. 6, at operation 610, the processing logic may receive, from the memory sub-system (e.g., the memory sub-system 110 of FIG. 1), a request to fetch data out of order. At operation 620, the processing logic may enable a configuration setting for out-of-order fetching. At operation 630, the processing logic may send, to the memory sub-system (e.g., the memory sub-system 110 of FIG. 1), a plurality of first data elements, wherein each first data element of the plurality of first data elements corresponds to a first die of a first set of dies (e.g., the SLC/MLC/TLC memory arrays 207 of FIG. 2). In some implementations, the plurality of the first data element is not stored in a sequential order in the host system, and each first data element of the plurality of first data elements is associated with a respective logical address range of a plurality of logical address ranges.

In some embodiments, the operations performed at operations 610 to 630 are performed repeatedly on a second die with second data, a third die with third data, etc. For example, for the second die with second data, the processing logic may receive the request, enable the configuration setting for out-of-order fetching, and send, to the memory sub-system (e.g., the memory sub-system 110 of FIG. 1), a plurality of second data elements, wherein each second data element of the plurality of second data elements corresponds to a second die of the first set of dies (e.g., the SLC/MLC/TLC memory arrays 207 of FIG. 2).

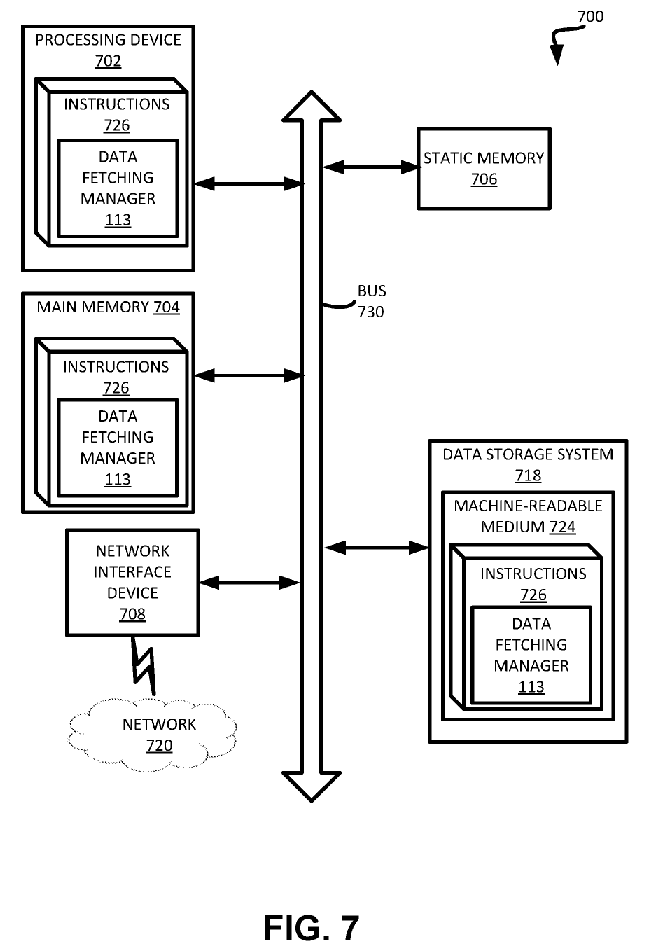

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1 ) that includes, is coupled to, or utilizes a memory sub- system (e.g., the memory sub-system 110 of FIG. 1 ) or can be used to perform the operations of a controller (e.g., to execute an operating system to perform operations corresponding to the data fetching manager 113 of FIG. 1 ). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term "machine" shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a command fetching logic management component (e.g., the data fetching manager 113 of FIG. 1 ). While the machine-readable storage medium 724 is shown in an example embodiment to be a single medium, the term "machine-readable storage medium" should be taken to include a single medium or multiple media that store the one or more sets of instructions. The term "machine-readable storage medium" shall also be taken to include any medium that is capable of storing or encoding a set of instructions for execution by the machine and that cause the machine to perform any one or more of the methodologies of the present disclosure. The term "machine-readable storage medium" shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory ("ROM"), random access memory ("RAM"), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:a memory device comprising a first set of dies and a second set of dies; anda processing device, operatively coupled with the memory device, to perform operations comprising:sending, to a host system, a request to fetch data out of order;fetching, from the host system, a plurality of first data elements, wherein each first data element of the plurality of first data elements corresponds to a first die of the first set of dies of the memory device;storing the plurality of first data elements in a write buffer of the system; andwriting the plurality of first data elements from the write buffer to the first die in parallel with performing a first folding operation by copying data from the first set of dies to the second set of dies of the memory device.

2. The system of claim 1, wherein a time difference between time used in writing the plurality of first data elements and time used in performing the first folding operation is less than time used in writing one first data element of the plurality of first data elements.

3. The system of claim 1, wherein the operations further comprise:responsive to completing performing the first folding operation, rotating the first die from the first set of dies to the second set of dies, and rotating one die of the second set of dies from the second set of dies to the first set of dies;fetching, from the host system, a plurality of second data elements, wherein each second data element of the plurality of second data elements corresponds to a second die of the first set of dies of the memory device;storing the plurality of second data elements in the write buffer; and
writing the plurality of second data elements from the write buffer to the second die in parallel with performing a second folding operation by copying data from the first set of dies to the second set of dies of the memory device.

4. The system of claim 1, wherein the operations further comprise:setting a field in the request, wherein the request comprises universal flash storage (UFS) protocol information units (UPIU).

5. The system of claim 1, wherein the plurality of first data elements is not stored in a sequential order in the host system, and wherein each first data element of the plurality of first data elements is associated with a respective logical address range of a plurality of logical address ranges.

6. The system of claim 1, wherein the first set of dies runs in at least one of: a single level cell (SLC) mode, a multi-level cell (MLC) mode, or a triple level cell (TLC) mode, and wherein the second set of dies runs in a quad-level cell (QLC) mode.

7. The system of claim 1, wherein time used in performing the first folding operation is a quad-level cell (QLC) programming cycle, and wherein time used in writing the plurality of first data is three times of a triple level cell (TLC) programming cycle.

8. A method comprising:sending, by a processing device, to a host system, a request to fetch data out of order;fetching, from the host system, a plurality of first data elements, wherein each first data element of the plurality of first data elements corresponds to a first die of a first set of dies of a memory device, wherein the memory device comprises the first set of dies and a second set of dies;storing the plurality of first data elements in a write buffer of the system; and
writing the plurality of first data elements from the write buffer to the first die in parallel with performing a first folding operation by copying data from the first set of dies to the second set of dies of the memory device.

9. The method of claim 8, wherein a time difference between time used in writing the plurality of first data elements and time used in performing the first folding operation is less than time used in writing one first data element of the plurality of first data elements.

10. The method of claim 8, further comprising:responsive to completing performing the first folding operation, rotating the first die from the first set of dies to the second set of dies, and rotating one die of the second set of dies from the second set of dies to the first set of dies;fetching, from the host system, a plurality of second data elements, wherein each second data element of the plurality of second data elements corresponds to a second die of the first set of dies of the memory device;storing the plurality of second data elements in the write buffer; andwriting the plurality of second data elements from the write buffer to the second die in parallel with performing a second folding operation by copying data from the first set of dies to the second set of dies of the memory device.

11. The method of claim 8, further comprising:setting a field in the request, wherein the request comprises universal flash storage (UFS) protocol information units (UPIU).

12. The method of claim 8, wherein the plurality of first data elements is not stored in a sequential order in the host system, and wherein each first data element of the plurality of first data elements is associated with a respective logical address range of a plurality of logical address ranges.

13. The method of claim 8, wherein the first set of dies runs in at least one of: a single level cell (SLC) mode, a multi-level cell (MLC) mode, or a triple level cell (TLC) mode, and wherein the second set of dies runs in a quad-level cell (QLC) mode.

14. The method of claim 8, wherein time used in performing the first folding operation is a quad-level cell (QLC) programming cycle, and wherein time used in writing the plurality of first data is three times of a triple level cell (TLC) programming cycle.

15. A non-transitory computer-readable storage medium comprising instructions that, when executed by a processing device, cause the processing device to perform operations comprising:sending, to a host system, a request to fetch data out of order;fetching, from the host system, a plurality of first data elements, wherein each first data element of the plurality of first data elements corresponds to a first die of a first set of dies of a memory device, wherein the memory device comprises the first set of dies and a second set of dies;storing the plurality of first data elements in a write buffer of the system; andwriting the plurality of first data elements from the write buffer to the first die in parallel with performing a first folding operation by copying data from the first set of dies to the second set of dies of the memory device.

16. The non-transitory computer-readable storage medium of claim 15, wherein a time difference between time used in writing the plurality of first data elements and time used in performing the first folding operation is less than time used in writing one first data element of the plurality of first data elements.

17. The non-transitory computer-readable storage medium of claim 15, wherein the operations further comprise:
responsive to completing performing the first folding operation, rotating the first die from the first set of dies to the second set of dies, and rotating one die of the second set of dies from the second set of dies to the first set of dies;
fetching, from the host system, a plurality of second data elements, wherein each second data element of the plurality of second data elements corresponds to a second die of the first set of dies of the memory device;
storing the plurality of second data elements in the write buffer; and
writing the plurality of second data elements from the write buffer to the second die in parallel with performing a second folding operation by copying data from the first set of dies to the second set of dies of the memory device.

18. The non-transitory computer-readable storage medium of claim 15, wherein the operations further comprise:setting a field in the request, wherein the request comprises universal flash storage (UFS) protocol information units (UPIU).

19. The non-transitory computer-readable storage medium of claim 15, wherein the plurality of first data elements is not stored in a sequential order in the host system, and wherein each first data element of the plurality of first data elements is associated with a respective logical address range of a plurality of logical address ranges.

20. The non-transitory computer-readable storage medium of claim 15, wherein the first set of dies runs in at least one of: a single level cell (SLC) mode, a multi-level cell (MLC) mode, or a triple level cell (TLC) mode, and wherein the second set of dies runs in a quad-level cell (QLC) mode.
